(19) United States
(12) Patent Application Publication
(10) Pub. No.: US 2025/0371578 A1
(43) Pub. Date: Dec. 4, 2025

(54) SYSTEM FOR MANAGING SERVICES MARKETPLACE

(71) Applicant: Walter Anderson, Tallulah, LA (US)

(72) Inventor: Walter Anderson, Tallulah, LA (US)

(21) Appl. No.: 18/811,112

(22) Filed: Aug. 21, 2024

Related U.S. Application Data
(60) Provisional application No. 63/652,904, filed on May 29, 2024.

(51) Int. Cl. G06Q 30/0251; G06Q 10/1053

(52) U.S. Cl. CPC G06Q 30/0257; G06Q 10/1053

(57) ABSTRACT

A system and method for managing the services marketplace for ensuring fair compensation and handling of any disputes. The system implements an interface on user devices that include worker device and employer device. Through multiple screens of the interface, an employer can post a job, and a worker can apply for the job. The system makes the process easy as well as ensures fair compensation and dispute resolution.

### CROSS-REFERENCE TO RELATED APPLICATIONS

This application claims priority from a U.S. provisional patent application Ser. No. 63/652,904, filed on May 29, 2024, which is incorporated herein by reference in its entirety.

### FIELD OF INVENTION

The present invention relates to a marketplace platform for services, and more particularly, to a system that allows managing search for a job, monitor the job, and facilitate payments.

### BACKGROUND

Employers create various job opportunities to support their operations, while candidates seek these opportunities to earn money. However, finding the right candidate for a job has always been a challenge for both the employer and the candidate. Typically, employers advertise the job through the press, job portals, and similar platforms. Once candidates learn about the job vacancy, they apply by submitting their resumes. The selection process involves multiple stages, including shortlisting candidates and final selections made by the employer. This process is laborious, expensive, and often leads to dissatisfaction for both parties.

It can be challenging for employers to hire candidates for short-term projects or tasks due to the complexity and costs involved. Similarly, it is tough for employees to find suitable jobs. Employees are often underpaid because there is a mismatch between job requirements and candidate profiles.

A need is therefore appreciated for a system to manage the services marketplace including monitoring the job progress and payments.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system for managing the services marketplace.

Another object of the present invention is that employers can easily post jobs and the reach of job advertisements can be significantly increased.

Still, another object of the present invention is that a user can quickly search for jobs.

A further object of the present invention is that job progress can be monitored.

Yet an object of the present invention is that the payment can be settled between the employee and an employer.

A further object of the present invention is that any grievances can be handled.

Still, a further object of the present invention is that the process of hiring can be made simple and cost-effective.

Yet a further object of the present invention is that the system can provide a reliable and immediate source of income.

An additional object of the present invention is that the system allows for fair compensation.

In one aspect, disclosed are a systema and method for managing services marketplace, the method implemented within a system comprising a processor and a memory, the method comprising implanting an interface on a worker device and an employer device; fetching job details posted by an employer through the employer device and stored in an advertisement database; and presenting a job advertisement screen of the interface on the worker device upon request by a worker, wherein the job advertisement screen comprises an upper section and a lower section, wherein the upper section is configured to display the job details, wherein the job advertisement screen is configured to be scrolled between the upper portion and the lower portion, wherein the scrolling of the job advertisement screen from the upper portion to the lower portion results in fetching of additional details from a profiles database, wherein the additional details comprises past jobs posted by the employer and compensation paid of each of the past jobs.

In one aspect, the method further comprises facilitating resolution of dispute between the worker and the employer through a job completion screen of the interface, wherein the job completion screen is configured to receive a complaint.

In one aspect, the method further comprises generating a dynamic profile of each of the employer and the worker, wherein the dynamic profiles are configured to be updated with information about jobs posted and/or jobs completed, wherein each of the dynamic profiles comprise a name, address, and contact details.

In one aspect, the request by the worker is received through a job search screen of the interface from the worker device, wherein the job search screen comprises a form with fields, the fields comprise a category of jobs, a date range, and a location.

In one aspect, the job details are posted through a job post screen of the interface, wherein the job post screen comprises a form for receiving details of a job, the detail of the job comprises photographs, location of the job, compensation, and timings of the job.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a block diagram showing the environment of the system, according to an exemplary embodiment of the present invention.

FIG. 2 is a block diagram showing the architecture of the system, according to an exemplary embodiment of the present invention.

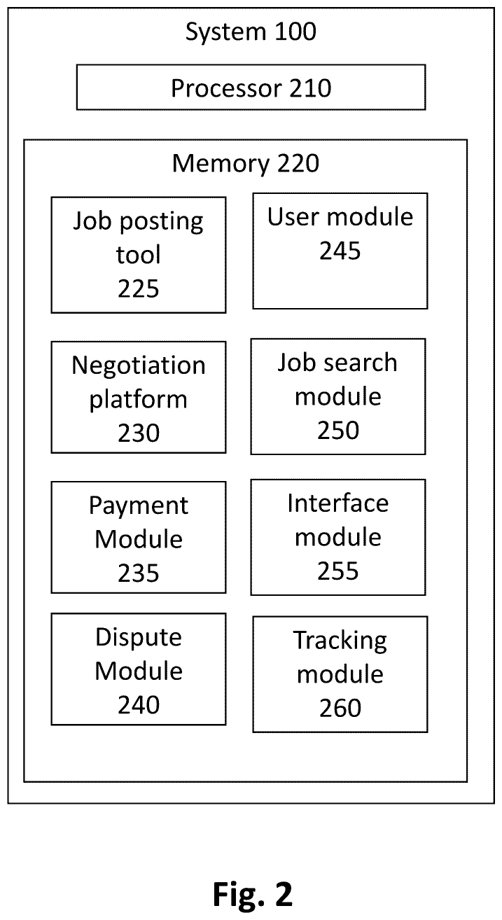

FIG. 3 shows a dashboard screen of an interface, according to an exemplary embodiment of the present invention.

FIG. 4 shows a screen for job search, according to an exemplary embodiment of the present invention.

FIG. 5 shows a screen for job postings, according to an exemplary embodiment of the present invention.

FIG. 6 shows a screen for a job advertisement, according to an exemplary embodiment of the present invention.

FIG. 7 shows a screen for job applications received, according to an exemplary embodiment of the present invention.

FIG. 8 shows a screen for job completion, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including” when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The described invention pertains to a system and method for managing the services marketplace. The described invention provides for advertising short-term jobs, tasks, and the like, which are referred to hereinafter as job(s). Also, the disclosed invention provides for quick searching of jobs through an intuitive interface. The disclosed invention allows for hiring a worker for a job and monitoring the progress of job completion. The disclosed invention can also handle payments to workers and facilitate resolving disputes. Thus, the claimed invention can make the whole process easy and efficient and handle disputes between an employer and an employee.

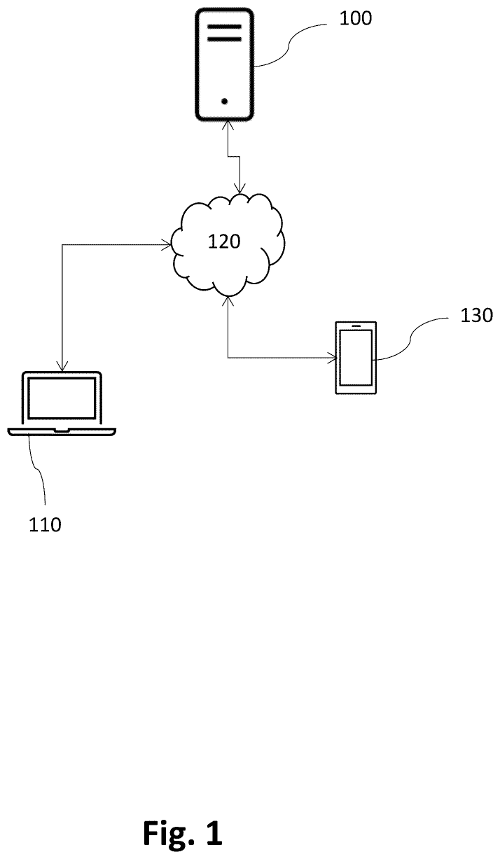

Referring to FIG. 1, a block diagram showing an environment of the disclosed system 100. The system 100 can connect to an employer device 110 and a worker device 130 through a network 120. The employer and the worker are also referred to herein as a user. The term “user” as used herein, and throughout this disclosure, refers to an individual engaging a user device to interact with the system. Similarly, the term user device encompasses employer devices and worker devices. The user device can be any computing device that includes a processor for processing instructions stored in memory. The user device can also include an input module for receiving input from the user. Such input can be in the form of a touch display, mouse, stylus, keyboard, touchpad, and the like. The user device may also include a display for presenting information to the user, for example, an LCD screen. The user device may also include a network circuitry for connecting to the network 120. Examples of the user device include a smartphone, a desktop computer, a laptop, a workstation, and the like.

The network can be a communication network known in the art which can be a wired network, a wireless network, or may include a combination of wired and wireless networks.

Examples of communication networks may be a local area network (LAN), a wide area network (WAN), a wireless WAN, a wireless LAN (WLAN), a metropolitan area network (MAN), a wireless MAN network, a cellular data network, a cellular voice network, the Internet, etc. While, for the purpose of illustration herein, FIG. 1 shows a single network connecting multiple user devices, it should be obvious to those reading this disclosure that different user devices can connect with the system through various networks, and the same user device can connect with the system through more than two networks. For example, a user device can connect to the system through a LAN and the Internet.

System 100 includes a processor 210 and a memory 220 operably coupled to the processor. The processor can be any logic circuitry that responds to, and processes instructions fetched from the memory. The memory may include one or more memory chips capable of storing data and allowing any storage location to be directly accessed by the processor. The memory can include modules according to the present invention for execution by the processor to perform one or more steps of the disclosed methodology.

The memory may include a job posting module 225 which upon execution by the processor can allow a user to post a job; a negotiation module 230 which upon execution by the processor can allow negotiation between an employer and a worker, the negotiation can be for a job; a payment module 235 which upon execution by the processor can allow an employer to pay for the job done by a worker; a dispute module 240 which upon execution by the processor can allow handing disputes between the employer and the worker; a user module 245 which upon execution by the processor can allow registration of user and communication between the users; a job search module 250 which upon execution by the processor can allow a user to search for a job; an interface module 255 which upon execution by the processor can provide an interface on a user device for interacting with the system; and a tracking module 260 which upon execution by the processor can allow tracking the progress of a job.

The term module as used herein and throughout this disclosure refers to software, a program code, a set of rules or instructions, and the like in one or more computer-readable languages including graphics, which upon execution by the processor performs one or more steps of the disclosed methodology. Also, operations may be described as a sequential process, some of the operations may be performed in parallel, concurrently, and/or in a distributed environment, and with program code stored locally or remotely for access by single or multi-processor machines. In addition, in some implementations, the order of operations may be rearranged without departing from the spirit of the disclosed subject matter.

The system can be implemented in the form of servers, which include cloud servers. The servers can be placed in one location or geographically dispersed. Also, one or more steps of the disclosed methodology can be performed on one or more user devices without departing from the spirit of the disclosed subject matter.

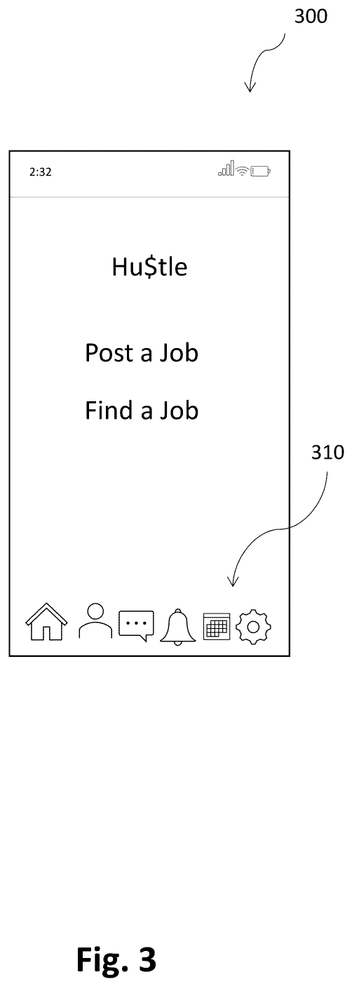

The interface provided by the interface module allows a user to interact with the disclosed system through a user device. The interface may include a series of screens, as shown in FIGS. 3-8, which in continuation can provide information as well as receive information from the user and execute one or more steps of the disclosed methodology. The interface can be dynamic and allows switching between sections, screens, pages, and the like quickly and easily. The interface can be provided as an application software that can be installed on the user device. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the World Wide Web. The application software can also be provided for the desktop environment, such as Windows™, Linux, and macOS. The user interface may permit interaction with a user through the user device, wherein information can be presented within the user interface by system 100 and information can be received by system 100 from the user.

The user module may allow an individual willing to use the disclosed system to register. The user module can receive basic information about the individual, such as name, contact details, email address, and the like. The user module can generate a profile for the user and store the same in a suitable database. The databases, including their structure and functioning, are known in the art. Also, the use of blockchain databases is well known. The present invention can use any suitable database without departing from the scope of the present invention. Also, the profile created by the user module can be later modified by the user. For example, FIG. 3 shows a dashboard screen 300 including an avatar icon in a navigation bar 310. Clicking the avatar icon opens up another screen that may present the profile as a form. The user has the option to edit entries or add more information, and the user module can update the respective profile in the database. The details of jobs posted by an employer or completed by a worker may be stored with their respective profiles. The user can also view any feedback given to them and ratings in the profile section.

The user module can generate login details to access the disclosed system securely. The login details may include at least a username and a password. The password can be an alphanumeric code, or biometric like a fingerprint, token, and the like. The user may have multiple login options, such as using an alphanumeric code or a fingerprint. Also, the use of multiple-factor authentication is within the scope of the present invention. The user can be provided with a login screen on the user device for accessing the disclosed system.

Some information from the profile can be used to generate a public profile. The public profiles can be visible to other users. In certain implementations, the public profile may include a photograph, name, brief discretion of skills, ratings, and location information. The public profile may also include options for contacting other users via messages, calls, video conferencing, and the like. For example, soft buttons can be provided on the public profile, wherein a user can click a respective soft button to message another user. Another option, through a soft button, can be provided for hiring the user. For example, clicking the “hire user” button can open another screen through which the job request can be posted to the user. The user can also post a review for another user through the public profile. Clicking a review button can open a review screen in which feedback for the user can be posted.

For each profile, suitable keywords can be generated based on the skill information in the profile. These keywords can be used to search a profile. For example, an employer may search using keywords like lawn moving and the profiles of the workers that can do lawn mowing can be presented to the employer. The employer may have an option to sort the profiles based on cost, location, and the like. The employer can review profiles and contact the worker through their respective public profile. The employer may also add workers as favorites, and could directly contact them for future jobs. For example, an employer may be happy with the job done by a worker, so the employer may add the worker's profile to his contacts, and the same is visible to the employer in their favorites section, from which the worker can be contacted directly in the future.

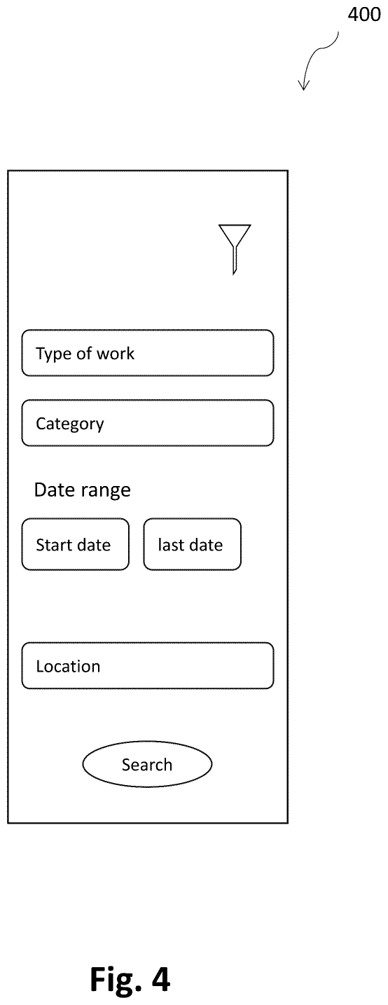

FIG. 4 shows a job search screen 400 that can be used to search for a job. When a user logs in using a login screen, the user can be presented with a dashboard screen, shown in FIG. 3. The dashboard screen includes two main options, one is to post the job, and the other is to find jobs. Clicking on the “find a job” button can open a screen of FIG. 4. The worker looking for a job can enter one or more fields, such as type of work, category, dates within which work is needed, and location. Not all the fields may be mandatory for searching but can help narrow down the results.

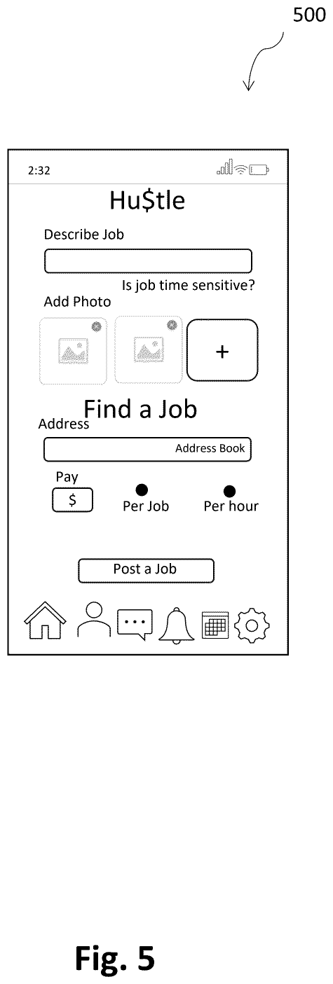

FIG. 5 shows a job posting screen 500 which opens up when the option “post a job” is clicked on the dashboard screen. The user can reach the dashboard screen anytime by clicking the home icon in the navigation bar. Again, referring to FIG. 5, the employer can enter details of the job, such as a description, photographs, location, timings, compensation, and the like. For example, the employer can post a job of lawn mowing, the employer can enter a description including the area of the lawn, availability of lawn mower, type of lawn mower, and the like in the description. Employers can also add photographs of the lawn, and more than one photograph can be added. Employers can also choose a mode of payment i.e., a fixed amount for the job, or on a per-hour basis.

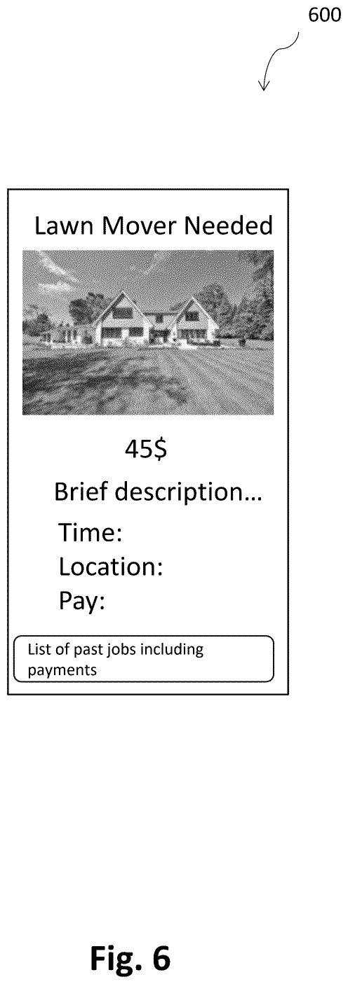

FIG. 6 shows how a job advertisement screen 600 may appear to others. The job advertisement may include information provided by the employer. The job advertisement screen may also present to the user more information about the employer such as rating of the employer, past jobs completed, payments made, disputes with the employer, and the like. This information may help the worker to ascertain the authenticity of the advertisement and assurance of payment. It is to be noted that not all the information may be visible on the advertisement screen. The user may scroll down the advertisement screen, which may cause the system to fetch additional details including past jobs from the employer profile, and present the same to the user. Thus, the main information can be obtained from the advertisement database, and additional details can be fetched from the profiles database.

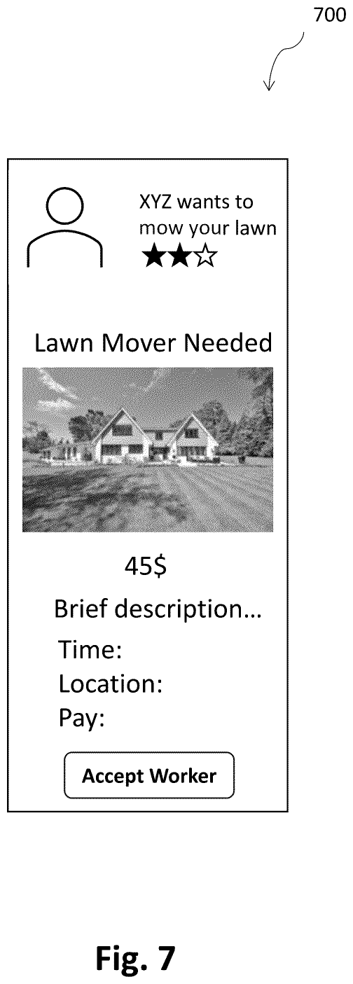

A worker can apply for the job from the advertisement screen, and the employer can be presented with a list of applications. The employer can review the application as desired by the employer, wherein the employer may have an option to sort the applications. An example of an application screen is shown in FIG. 7. The application screen 700 can combine the information from the job advertisement and the worker's profile and present the same to the employer. The job application screen may also have a “button” clicking which an agreement is made between the employer and the respective worker for the job, and a notification is sent to the worker. The navigation bar may include a notification icon, clicking which, a notification screen can be displayed to a user.

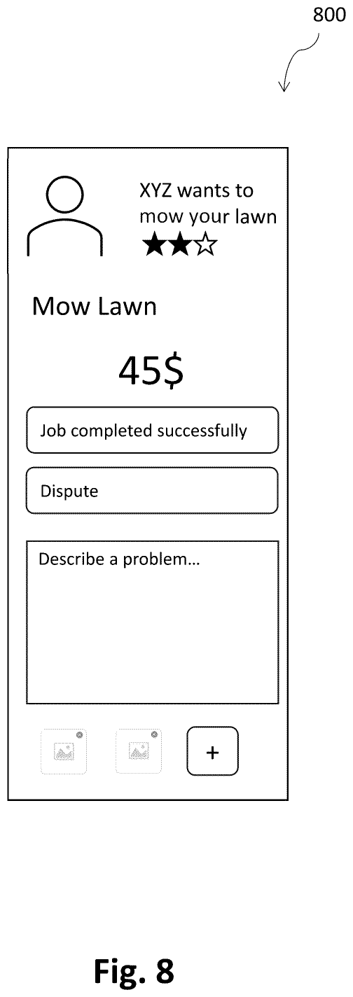

Upon job completion, the worker can mark that the job is completed using the interface provided by the system. Upon job completion, a job completion screen 800 may be presented to the user, as shown in FIG. 8. The job completion screen may allow the employer to make payment or raise a dispute. The employer can describe the problem. The system allows the employer and the worker to resolve the dispute.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for managing services marketplace, the method implemented within a system comprising a processor and a memory, the method comprising:
implanting an interface on a worker device and an employer device;
fetching job details posted by an employer through the employer device and stored in an advertisement database; and
presenting a job advertisement screen of the interface on the worker device upon request by a worker, wherein the job advertisement screen comprises an upper section and a lower section, wherein the upper section is configured to display the job details, wherein the job advertisement screen is configured to be scrolled between the upper portion and the lower portion, wherein the scrolling of the job advertisement screen from the upper portion to the lower portion results in fetching of additional details from a profiles database, wherein the additional details comprises past jobs posted by the employer and compensation paid of each of the past jobs.

2. The method of claim 1, wherein the method further comprises:
facilitating resolution of dispute between the worker and the employer through a job completion screen of the interface, wherein the job completion screen is configured to receive a complaint.

3. The method of claim 1, wherein the method further comprises:
generating a dynamic profile of each of the employer and the worker, wherein the dynamic profiles are configured to be updated with information about jobs posted and/or jobs completed, wherein each of the dynamic profiles comprise a name, address, and contact details.

4. The method of claim 1, wherein the request by the worker is received through a job search screen of the interface from the worker device, wherein the job search screen comprises a form with fields, the fields comprise a category of jobs, a date range, and a location.

5. The method of claim 1, wherein the job details are posted through a job post screen of the interface, wherein the job post screen comprises a form for receiving details of a job, the detail of the job comprises photographs, location of the job, compensation, and timings of the job.

6. A system for managing services marketplace, the system comprising a processor and a memory, wherein the system is configured to implement a method comprising:
implanting an interface on a worker device and an employer device;
fetching job details posted by an employer through the employer device and stored in an advertisement database; and
presenting a job advertisement screen of the interface on the worker device upon request by a worker, wherein the job advertisement screen comprises an upper section and a lower section, wherein the upper section is configured to display the job details, wherein the job advertisement screen is configured to be scrolled between the upper portion and the lower portion, wherein the scrolling of the job advertisement screen from the upper portion to the lower portion results in fetching of additional details from a profiles database, wherein the additional details comprises past jobs posted by the employer and compensation paid of each of the past jobs.

7. The system of claim 6, wherein the method further comprises:
facilitating resolution of dispute between the worker and the employer through a job completion screen of the interface, wherein the job completion screen is configured to receive a complaint.

8. The system of claim 6, wherein the method further comprises:
generating a dynamic profile of each of the employer and the worker, wherein the dynamic profiles are configured to be updated with information about jobs posted and/or jobs completed, wherein each of the dynamic profiles comprise a name, address, and contact details.

9. The system of claim 6, wherein the request by the worker is received through a job search screen of the interface from the worker device, wherein the job search screen comprises a form with fields, the fields comprise a category of jobs, a date range, and a location.

10. The system of claim 6, wherein the job details are posted through a job post screen of the interface, wherein the job post screen comprises a form for receiving details of a job, the detail of the job comprises photographs, location of the job, compensation, and timings of the job.
